(19) United States
(12) Patent Application Publication
(10) Pub. No.: US 2009/0083312 A1
(43) Pub. Date: Mar. 26, 2009

(54) DOCUMENT COMPOSITION SYSTEM AND METHOD

(76) Inventor: Kevin P. O'Neil, Valley City, OH (US)

Correspondence Address: Fay Sharpe LLP, 1228 Euclid Avenue, 5th Floor, The Halle Building, Cleveland, OH, 44115-1843, US

(21) Appl. No.: 12/233,684

(22) Filed: Sep. 19, 2008

Related U.S. Application Data
(60) Provisional application No. 60/994,510, filed on Sep. 20, 2007.

(51) Int. Cl. G06F 17/30

(52) U.S. Cl. 707/102; 707/100; 707/E17.044

(57) ABSTRACT

A method and a system is provided for composing a document for a selected topic based on a plurality of information sources. The document composition system includes a note gathering module including a first display window for acquiring a plurality of notes from the plurality of associated information sources. A topic writing project database is provided in communication with the note gathering module and is capable of receiving and storing the plurality of notes. A note indexing module is provided in communication with the writing project database and includes a second display window for prioritizing the plurality of notes. The plurality of notes can be indexed into a series of logically related writing categories. A note consolidating module is provided in communication with the writing project database, the note consolidating module including a third display window for consolidating select ones of the plurality of notes to create the document.

A claim for domestic priority is made herein under 35 U.S.C. §119(e) to U.S. Provisional App. Ser. No. 60/994,510 filed on Sep. 20, 2007, the entire disclosure of which is incorporated herein by reference.

### BACKGROUND

The present exemplary embodiment relates to the field of data processing. It finds particular application in conjunction with methods and systems for composing documents and will be described with particular reference thereto. However, it is to be appreciated that the present exemplary embodiment is also amenable to other like applications.

Various types of document composition systems or word processing systems for composing or drafting a document are known in the art. However, the prior art systems are deficient in a number of ways. First, the prior art systems do not allow a user or author of a document to construct or draft a document using a building block type approach. In addition, the individual components of the documents such as the ideas, thoughts, concepts, quotes, facts, or conclusions that comprise any given document cannot be captured, stored, or otherwise individually manipulated or maintained as part of a database.

Furthermore, the prior art systems employ techniques for collecting, storing, and organizing information that are deficient. For example, 3″×5″ note cards or manila files do not permit the author to conveniently retrieve or organize the piecemeal information that is usually acquired during the research stage of the document composition process. In addition, even computerized or electronic word processors (e.g. Microsoft Word) cannot collect or store individual pieces of information or “notes” in a structured manner and efficiently allow the user to control or rearrange the placement of the research notes for purposes of creating an articulated flow of information. Similarly, database programs (e.g. Microsoft Access) may be efficient and effective at storing large amounts of information but are not designed for manipulating ideas, thoughts or concepts as it pertains to the assembly of various data elements (e.g. research notes, etc.) collected during the production or composition of a document.

In practice, today's student or professional may have to employ several organizational systems and devices to accomplish the task—word processors, database programs, index note cards, manila folders, paper pads, notebooks, pens, sticky notes, highlighters, etc. As such, the research and drafting of a document via these prior art techniques and systems can be confusing, frustrating, disorganized, and inefficient.

Accordingly, it is an object of the present invention to develop a new and enhanced document composition system which would overcome the foregoing difficulties and others while providing better and more advantageous results.

### BRIEF DESCRIPTION

According to one aspect of the present invention, a method is provided for composing a document using a document composition system for a selected topic based on a plurality of information sources. A topic specific writing project is created including a topic specific database via a database module. A data element is received into a first display of the system via the information gathering module. The data element is stored in an uncategorized portion of the database. The steps of receiving and storing are repeated to form a collection of data elements in the database. The collection of data elements is indexed in a second display of the system into a plurality of categories via the information categorizing module to form a series of articulatable data elements. The series of articulatable data elements of the collection are consolidated in a third display of the system via the information consolidating module to form the document.

According to another aspect of the present invention, a document composition system for creating a document on a selected topic based on a plurality of associated information sources is provided. The document composition system includes a note gathering module including a first display window for acquiring a plurality of notes from the plurality of associated information sources. A topic writing project database is provided in communication with the note gathering module and is capable of receiving and storing the plurality of notes. A note indexing module is provided in communication with the writing project database and includes a second display window for prioritizing the plurality of notes. The plurality of notes can be indexed into a series of logically related writing categories. A note consolidating module is provided in communication with the writing project database, the note consolidating module including a third display window for consolidating select ones of the plurality of notes to create the document.

According to yet another aspect of the present invention, a computer program product including a computer-usable data carrier storing instructions is provided such that, when executed by a computer, causes the computer to perform a method including the steps of: creating a topic specific writing project including a topic specific database via a database module; receiving a data element into a first display of the system via an information gathering module; storing the data element in an uncategorized portion of the database; repeating the steps of receiving and storing to form a collection of data elements in the database; indexing the collection of data elements in a second display of the system into a plurality of categories via an information categorizing module to form a series of articulatable data elements; and consolidating the series of articulatable data elements of the collection in a third display of the system via an information consolidating module to form the document.

Still other aspects of the invention will become apparent from a reading and understanding of the detailed description of the preferred embodiments hereinbelow.

### BRIEF DESCRIPTION OF THE DRAWINGS

The present invention may take physical form in certain parts and arrangements of parts, preferred embodiments of which will be described in detail in this specification and illustrated in the accompanying drawings which form a part of the invention.

FIG. 1 is a diagrammatic overview of a writing project organizer document composition system including a plurality of modules, according to the present invention.

FIG. 2 is a detailed flow diagram illustrating a writing project module of the system of FIG. 1 for creating and opening a topic specific writing project.

FIG. 3 is a detailed flow diagram illustrating a data collection module of the system of FIG. 1 for collecting topic specific data and reference information from new sources or pre-existing topic specific writing projects.

FIGS. 4A-4B represent a detailed flow diagram illustrating an indexing module of the system of FIG. 1 for sequencing or sorting a plurality of note categories and or a plurality of individual notes or data elements within a note category into a logical flow or articulatable order.

FIG. 5 is a detailed flow diagram illustrating a consolidating module of the system of FIG. 1 for consolidating or concatenating the plurality of notes or data elements into a cohesive document and allowing the user to review and edit the document.

FIG. 6 is diagrammatic representation of the various folders of a topic specific writing project of the system of FIG. 1.

FIG. 7 is an exemplary diagrammatic representation of the various folders of the topic specific writing project of FIG. 6, illustrating specific note or date entries, author/reference information, and document setup preferences.

FIG. 8 is an exemplary representation of a note entry display screen of the data collection module of the system of FIG. 1.

FIG. 9 is an exemplary representation of a note search display screen of the data collection module of the system of FIG. 1 for locating relevant notes used in other previously created topic specific writing projects.

FIG. 10 is an exemplary representation of a citation builder display screen of the data collection module of the system of FIG. 1 for creating a particular citation format to be used in the topic specific writing project.

FIG. 11 is an exemplary representation of a reference information entry display screen of the data collection module of the system of FIG. 1 for obtaining source reference information for each of the plurality of individual notes in the topic specific writing project.

FIG. 12 is an exemplary representation of a group or category editing display screen of the indexing module of the system of FIG. 1.

FIG. 13 is an exemplary representation of an organizing and consolidating display screen of the review/consolidating module of the system of FIG. 1.

### DETAILED DESCRIPTION

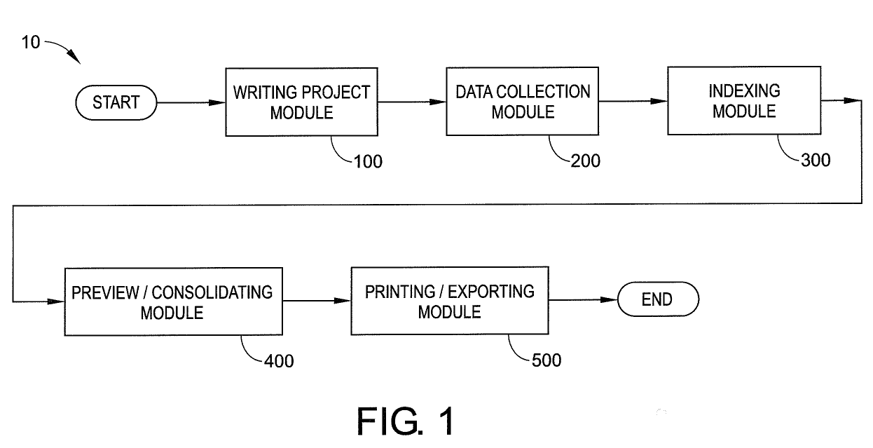

With reference to FIG. 1, a document composition system or writing project organizer 10 includes a writing project module 100, a data collection module 200, an indexing module 300, a review/consolidating module 400, and a printing/exporting module 500. In addition, FIG. 1 depicts a high level overview of the method of operation of the system 10. It should be noted that the system 10 can be operated as a computer program in conjunction with a conventional computer or any other known digital computing means. For example, such a computer or computing means could include but is not limited to a central processing unit (CPU) for running one or more computer programs, memory storage devices for the CPU, data input devices (e.g., a keyboard, mouse, scanner, etc.), and output devices (e.g., a display device, printer, etc.). Furthermore, it should be noted that the system and method of the present invention could be operated or performed, in whole or in part, over the Internet as a web based application, LAN, or over a remote or local computer based network.

Generally, the writing project module 100 opens or creates a topic specific writing project. Once the topic specific writing project is opened or created the data collection module 200 permits the user of the system 10 to enter or gather and store a plurality of specific data elements or “notes” that are relevant to the instant writing topic. A note can be a short sentence, phrase, paragraph of any thought or concept that can be captured in text or graphics. In addition to collecting the plurality of notes, the data collection module 200 is capable of capturing certain reference information (e.g. author, publisher, book title, etc.) associated with each of the respective plurality of notes. As the notes are collected they are stored in a database in a specific topic category or in a pending category. At the option of the user, the notes can be indexed, sequenced in a user-arranged order, or otherwise sorted at any time via the indexing module 300. The indexing module allows the user to place the collected, pending, unsorted or uncategorized plurality of notes into specific categories and/or subcategories grouping them together in a sequence or flow to form a series of articulatable notes or data elements. The term “articulatable” is to be broadly defined to mean any logical progression of notes or data elements that when read or interpreted in a generally sequential manner are coherent and capable of being understood by an individual having at least some peripheral knowledge involving the context of the notes or data elements. In short, when so arranged or organized, the elements can be “articulated.”

Once the plurality of notes have been indexed to the satisfaction of the user, the notes may be reviewed and or consolidated in a separate display by the review/consolidating module 400. At this point, the user may continue to edit or re-sequence the notes as part of a page format. Finally, the printing/exporting module 500 allows the user to print, save, or export the consolidated document to another program or system for further processing.

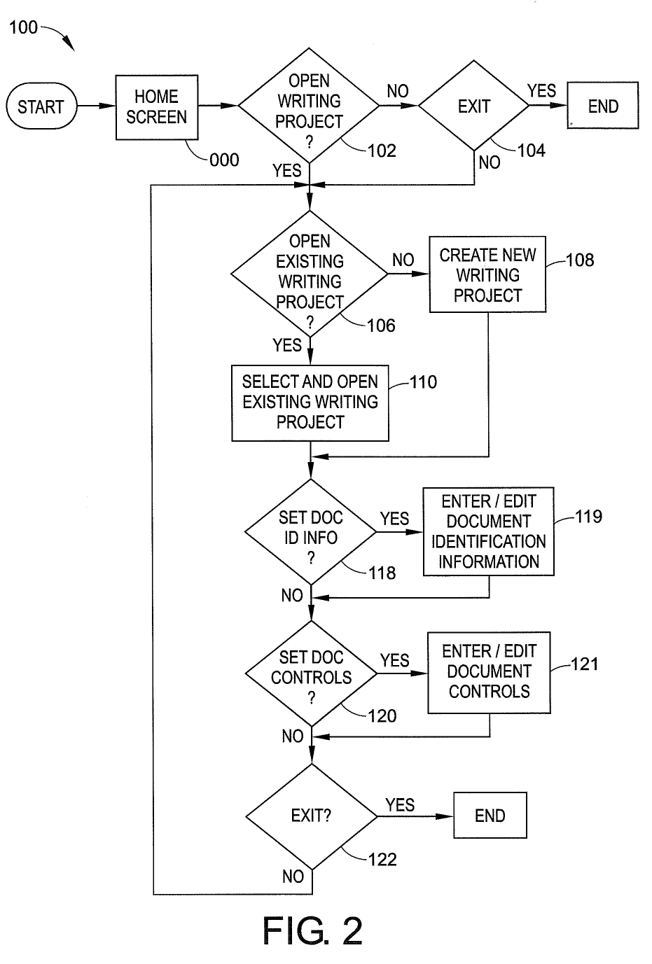

With reference to FIG. 2, a detailed method of operation of the writing project module 100 is illustrated. The writing project module 100 effectively starts the writing process and is used to contain all the notes associated with the writing project. From a Home Screen 000 of the system the user decides to open a new writing project or not 102 or open an existing writing project 106. The user may also opt to exit at this point 104 end the module function and return to the Home Screen 000. If a decision is made to open a new writing project, the user selects “Open New Writing Project” from the toolbar and is prompted to create a project folder and provide a short name descriptive of the new writing project 108. The newly named topic specific writing project will contain all the notes and reference citation information associated with the research for this document composition. Regardless if an existing writing project is selected 110 or a new project is created 108 the system can be set to prompt the user to edit certain document properties. If the user chooses to edit the properties, the system will request that specific Identification Information be provided, such as Writer's Name, Title of Document, Date of Writing, etc. These requested fields are found under “Document Identification Information” on the toolbox. The system can also require Document Controls to be set 120. Document Controls are citation, footnote, endnote, bibliography, table of contents, author reference and the like parameters that apply to the entire writing project document. For this, the user can select an indicator setting which determines how the citations formats are to be handled and choose either footnotes or endnotes 121. The system may require the footnote/endnote and bibliographic formats to be user-defined through a build-your-own citation builder screen where the user drags and drops in the citation fields and provides the punctuation requirements. Once the document parameters are captured, the user may decide 122 to end the module function and return to Home Screen 000 or to repeat the process.

It is possible within an existing writing project for the user to change one's mind and reset document settings. At any time, the user has the option to revise the Document Identification Information parameters 119. The process can be performed by selecting and opening the existing writing project 106, from the toolbar and entering either Document Identification information 119 or Document Controls process 121 and making the new criteria selections.

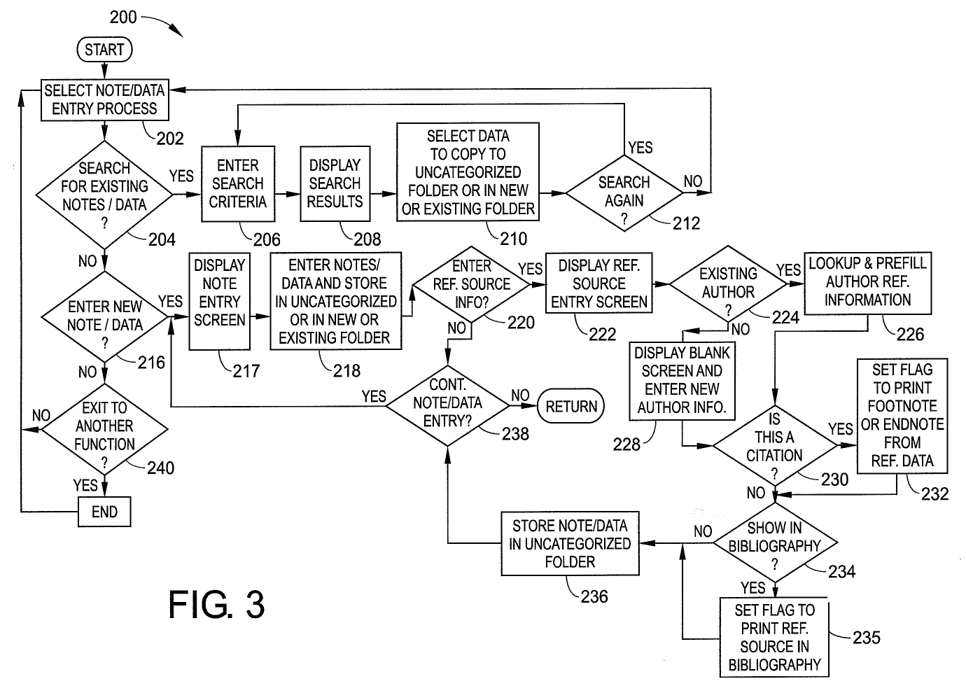

Now with reference to FIG. 3, a method of operation of the data collection module 200 is shown. The data collection module generally represents the research and information gathering stage involved with composing a given document. Various types of documents may be composed such as a research paper, a report, a presentation, or an article or any other written embodiment such as memoranda, screen scripts, technical manuals, essays, etc. With respect to the present invention, the information gathering process may involve the user typing, cutting and pasting, voice entry or any other means of data transmission to text. Various textual pieces of information, such as sentences, paragraphs, concepts, ideas, facts, opinions or quotations are stored as “notes.” As mentioned previously, the notes may be as short as a few words or as long as a few paragraphs and need not be limited to text but could also include visual graphics.

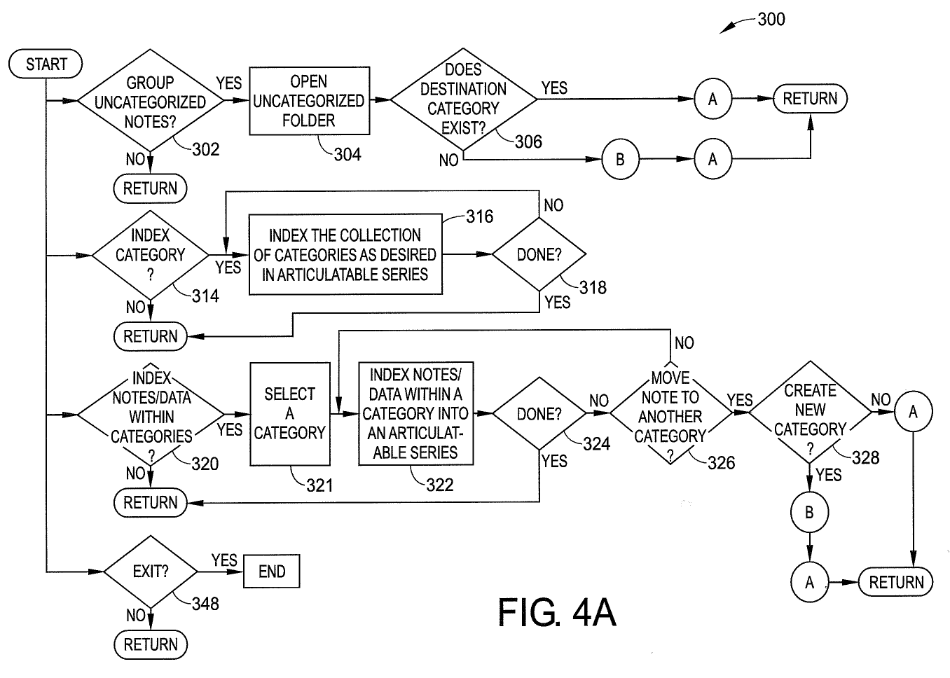

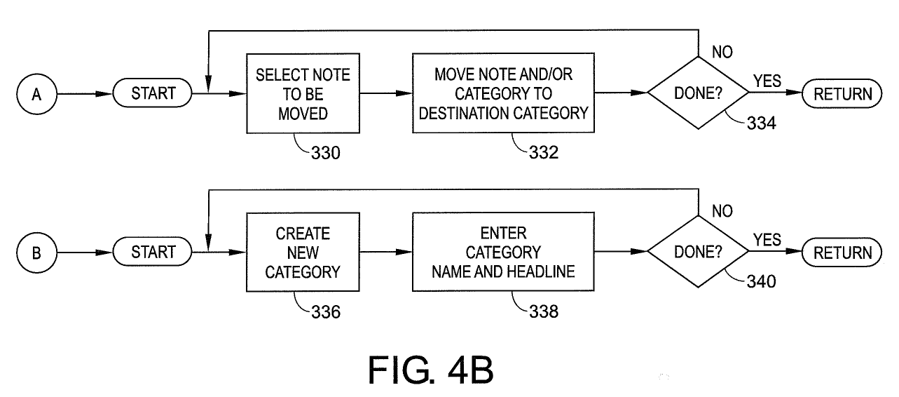

With continued reference to FIG. 3, the user begins the note entry process 202 from several available options. The user may select a search option 204 to obtain notes from a prior writing projects for use in the instant or current writing project. If the search option 204 is executed, the user has the opportunity to search out existing, pertinent notes from other writing project databases and incorporate them by transferring them into the present document composition. In this scenario, the user enters search criteria 206 to identify appropriate notes. A search is conducted on all or specific writing project databases and on criteria such as keyword phrase, listbox of titles, listbox of author names, etc. The search results (comparison “hits”) are then displayed for the user to review 208. The user has the ability to select and copy into the current writing project only the resulting notes desired 210. The notes may be copied into a standard uncategorized folder category which acts as a pending folder or in a new or existing category folder of the database. In either case, the note will remain in that folder until the user performs an indexing and categorization process 300 as described in FIG. 4. The user may continue repeated searches under different criteria until the user is satisfied that all pertinent notes have been gathered 212.

During the data collection process, the user may also choose to enter new notes directly 216. If this option is executed, the user is directed to a note entry screen 217 where the user is permitted to enter note information 218. A note entry section is provided where the user can use various entry methods through typing, copying and pasting function, voice to text entry, etc. In addition, the system may include a document scanning module or process that can be utilized to permit the user to highlight various portions of the scanned document and submit the highlighted portions as a note entry. The scanning module would be helpful not only in gathering information but also if an existing document needs to be rewritten and reorganized. For example, the highlighted or selected information could be efficiently deconstructed, rearranged, and reassembled.

Once the note has been entered, the note information is then stored in the Uncategorized Folder or in a new or existing category folder of the database. The user has the option to enter details regarding the note's reference source 220. If a reference source is not required, for example, as in an instance where the user enters one's own thoughts, ideas or sentences, the system allows the user to decide to enter another note 238 or to exit this function.

If the user decides to enter a reference source 220, the user sets a reference source flag indicator to “on” in the Note Entry screen. If the reference source flag indicator is “on” an event occurs to display the Reference Source entry screen 222. This screen contains fields in which to enter a referenced author's bibliographic information such as, but not limited to, the following: Author Last Name, Author First Name, Title, etc. This information may then be recalled for use or displayed elsewhere in the document (e.g. table of authorities, works cited page, footnotes, etc.). A feature of this screen or module is that it may include an author name lookup utility which allows the user to select an author if the generic data has been previously entered to the database 224. This function pre-fills author data on the reference source screen which saves the user data entry time. The user adds or changes information pertaining to the particular reference note as needed 226. If the author has never been entered into the system before, the author's name will not be listed and the user will need to enter all initial data into blank fields 228.

Once the reference source information has been entered, the user has the option to indicate whether this note is a “direct” quote or borrowed idea that requires formal citation by a footnote or endnote in the document 230. If the note entry needs to be cited, the user sets a direct quote flag indicator to “on” 232. The direct quote flag indicator controls the printing of a footnote/endnote. An “on” condition will print the reference source information in a footnote/endnote format. If the direct quote indicator is not “on”, no printing of footnote/endnote information will occur. Another flag indicator appearing on this screen controls the printing and suppression of the reference source in the bibliography 234. If the user wishes to print a referenced source in the bibliography, a bibliography flag indicator is set to “on” condition 235. If the condition is not set to “on”, the reference source will not be displayed in the bibliography. The final step in this process is to write the information to the database tables. Since the note entered is new, it will be stored and automatically categorized as “Uncategorized” 236 and will be displayed in the “Uncategorized” default folder until the user decides to perform the categorization and grouping process 300. Next, the user decides to either continue or discontinue the note entry function 238.

Lastly, with respect to the data collection module 200, the user may elect to exit to another function 240. The user has the option to exit or to go to other writing project activities. If the user decides to exit then the user returns to the home screen where the user may enter any of the other previously discussed modules or other writing projects.

With reference to FIGS. 4A-4B, a detailed method of operation of the indexing module 300 of the writing project organizer or system is illustrated. The indexing module 300 is generally responsible for the processes of creating and organizing categories and subcategories and for organizing the plurality of individual notes either within or among the various categories. When categories are created they are named. The categories are then used to store the plurality of notes. The plurality of notes can then be organized sequentially within the category (referred to as “indexed”).

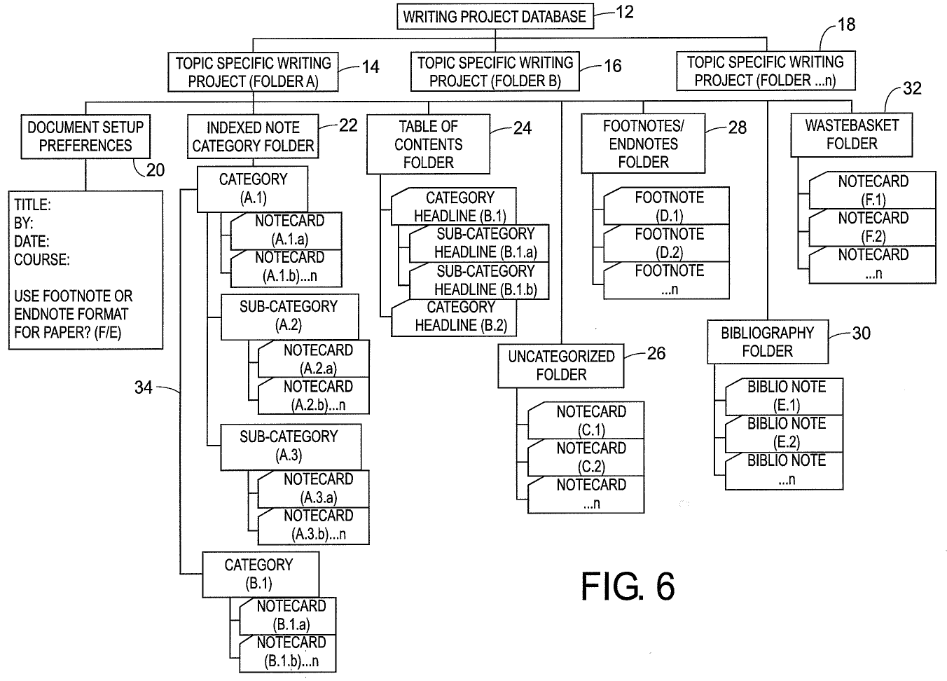

The user may begin the category and note indexing process from several available options. For example, the user may first elect to begin organizing or indexing notes that were previously stored in the “uncategorized” category/folder 302. If this option is chosen the uncategorized folder 304 is opened and the user is presented with a display of the notes previously entered and saved to this folder during the note entry performed via the data collection module 200 (FIG. 3). For example, a user may wish to organize the notes taken during a session after researching several books. If the user had already created an appropriate destination category 306 describing the particular type of note, the user would then select the note 330 and deposit or move the note into that category 332. This moving action can occur by any commonly known technique. For example, a traditional graphical user interface (GUI) may be used to “drag and drop” the note to the named category or to activate a listbox feature to click-identify the proper or destination category. If a category folder does not exist that is descriptive of the essence of the note, the user can create a new category folder 336 with an appropriate category name 338 and headline (a headline is a short definition or descriptive title of the category). Again, this can be done in any number of ways such as by right-clicking on the listbox, navigating a toolbar, or by pressing a function key command. Once the user enters the new category name, the new category is added to the writing project database. In addition the new category can be added and later accessed in a category hierarchy tree 10 (FIG. 6). This process of creating categories and assigning notes to existing and new categories may continue over one or several writing sessions or until all the notes have been categorized 334, 340.

With continued reference to FIGS. 4A-4B, the user may also choose to sequence or index the categories 314 such that the categories themselves flow in an articulated manner and represent a logical flow of statements, facts, ideas or concepts. As before, the user can index or rearrange any category folder 316 (by, e.g. pointing, dragging and dropping) in the hierarchy tree and move it to another position within the tree. The user can repeat the organizational process 318, until the user is satisfied with the arrangement of the category folders and their corresponding hierarchy structure. Similarly, the user may choose to sequence the notes within the group or category 320. If the user wishes to sequence the notes of a given category, the user selects the desired category 321 (such as by double clicking, right clicking, depressing a function key or highlighting the category folder). Once selected, the unsequenced (random or entry ordered) notes contained in the category folder are displayed permitting the user to quickly index the each of the notes with respect to the others as necessary to form a cohesive or organized and articulatable series of notes 322. The user may accomplish this indexing process, for example, by selecting the note to be moved and dragging it into a new position within the same category. The process is repeated if multiple notes 324 need to be moved to another existing category 326 and the category already exists 328, the note is then selected 330 and moved to that category 332 on the index hierarchy tree. If the note is not appropriate for an existing category 328, a new category or subcategory can be created 336, a title or headline provided 338 and then the selected note 330 can be moved into the new or destination category 332. The note is then stored in that category. Lastly, the user has the option to continue sequencing notes within categories 324 or to exit the indexing module altogether 348.

As such, the user has the option to move notes from one category to another category. If the note needs to be moved to another existing category the user can do so by simply selecting the note to be moved and moving it to the existing destination category. If the user determines that a new category is required then the user can create a new category or subcategory. When a new category or subcategory is created, the user enters the category name or headline title name 338.

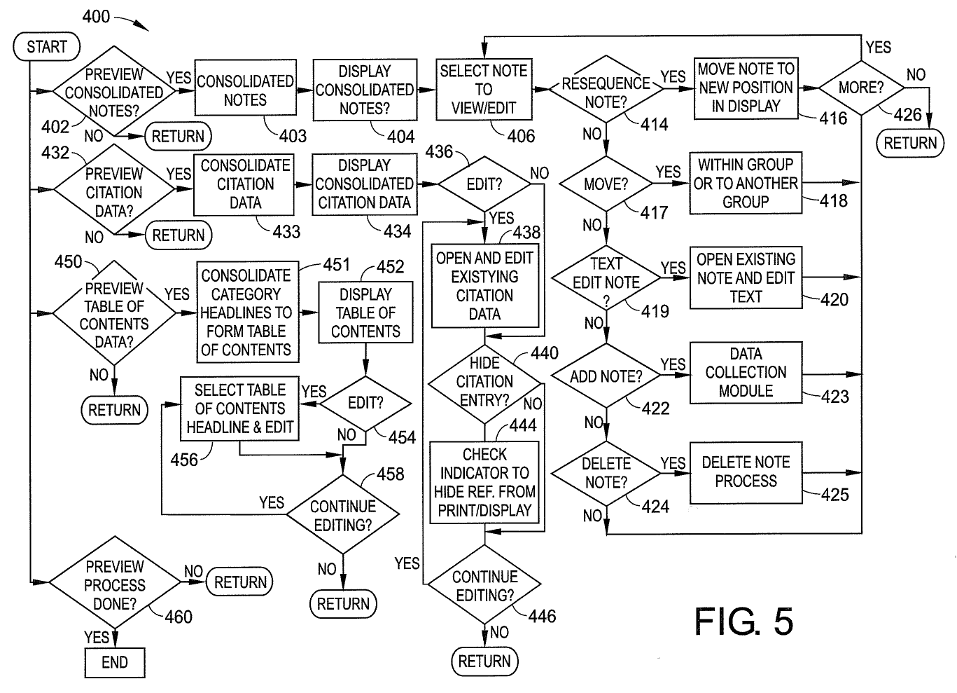

With reference now to FIG. 5, a detailed method of operation of the consolidating and preview module 400 of the system is illustrated. Generally, the consolidating and preview module 400 consolidates the sequenced or indexed notes of the writing project and presents a preview of the notes in a preview display. In addition, various citation data (such as bibliography, footnote, and endnote data) is also available for preview. The module 400 allows the user to view the entire writing project from beginning to end in a logical word processing format with the “notes” in the order as sequentially arranged or indexed by the indexing module 300 (FIG. 4). The individual categories and their respective note content can also be displayed, edited, and rearranged while in the preview display. A textual display of the note information can be displayed in one portion of the preview display while the categories are displayed in another. As the user manipulates the information (e.g. edits, drag and drops information to other categories or rearranges the information into another position) the preview pane text is subsequently updated and redisplayed.

With continued reference to FIG. 5, the user can elect from a number of options. First, the user may elect to preview the current writing project 402. When this option is selected, the notes are consolidated 403 and presented in a preview display 404. In addition, the display can be divided into a first and second portion with the consolidated notes appearing in the first portion and the individual notes comprising the consolidated notes appearing in the second portion. The notes being displayed in the second portion may be selected by the user for further editing 406. The user may perform any number of functions such as but not limited to: editing, moving the note to another category in the category tree hierarchy, moving the note to another position within the category, etc. The process begins by click selecting (or any other method of selecting the category via toolbar, right-click, F-key, etc.) a note to be edited 406. Once the notes and text appear in the second portion of the preview display, the user can make a change to the order, priority, sequence of the note 414 by moving the note to a new position in the display 416; move the note 417 within a category or to another category 418; edit the note text 419, 420; add a note 422 via a data collection module link 423; or delete a note within a category 424, 425.

If the user wishes to re-sequence notes 414, the user selects the note in the note display and drags it to a new position within the group 416. If the user wishes to move a note to another category 417, the user selects the note in the first portion of the preview display and drags it to a new category within the category hierarchy tree 418. If the user wishes to edit a note 419, the user opens the note and edits the text and saves the entry 420. If the user wishes to add a note 422, the user opens a new note, enters the note text and saves the note to the respective category 423. If the user wishes to delete a note 424, the user selects the note and deletes it by delete key or equivalent command 425. Upon completion of any of the functions noted, specifically, note re-sequencing, note text editing, adding a note, deleting a note, the user has the option to continue the preview edit sentence flow process or to exit the process 426.

With continued reference to FIG. 5, the user may also elect to preview the various citation data associated with the notes of the writing project 432. When the user selects the preview citation data option 432, the citation data is consolidated 433 and the consolidated citation data is presented in a citation preview display 434. In addition, the user may edit the citation data 436. If the user wishes to edit the bibliographic entry 436, the user selects a citation entry and edits the text as desired 438. If, instead, the user wishes to hide the citation entry 440, then the user can toggle (e.g. via a checkbox) to disable the printing of the citation data or entry 444. If the hide option is not desired, the user may go to the next citation entry 446 and either continue performing editing exit the citation preview display.

Similarly, the user may also elect to preview the table of contents (TOC) 450. When the user selects the preview TOC the headlines from the categories of the writing project are consolidated 451 to form a TOC corresponding to the order in which they have been indexed or arranged. The TOC is generated from the category headlines from all levels of category and subcategory. Every headline has the option of being displayed, hidden or edited for display in the print process. The consolidated TOC is then presented in a TOC preview display 452. The user may also edit the TOC 454, by selecting the individual headline or entry 456. If the user wishes to go to the next headline and continue editing they may do so 458, otherwise the user can exit the footnote/endnote category. Once the user has finished previewing they may exit 460 the consolidating and preview module and or preview displays and resume at another time. Lastly, when the user is satisfied with the consolidate writing project document, the user may choose to do any standard file and document functions such as print, save, or export the consolidated writing project to a word processing program for further refinement.

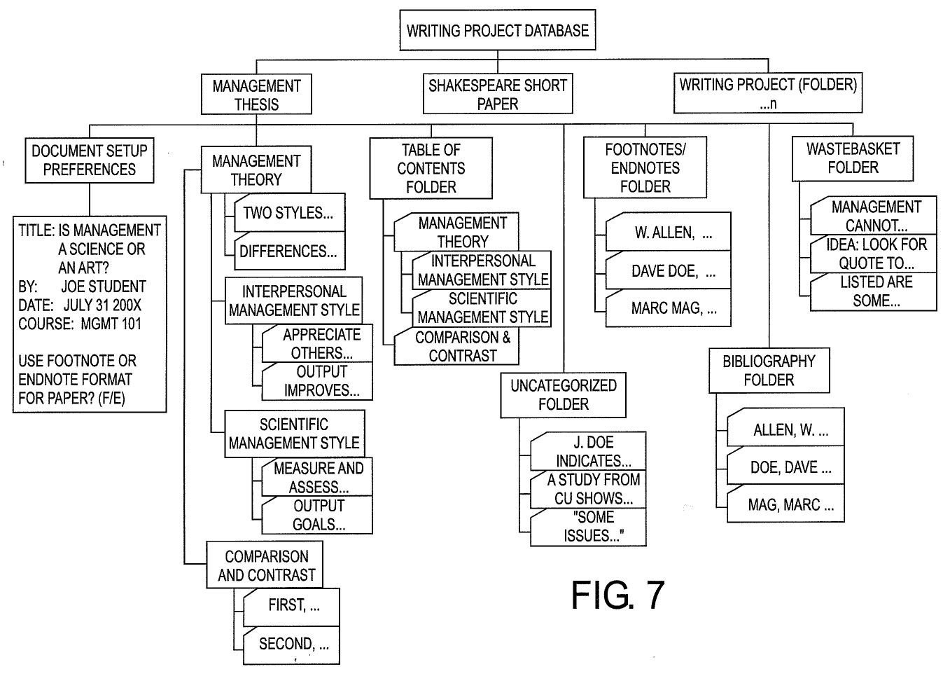

Now with reference to FIG. 6, a folder structure diagram of the writing project organizer system is illustrated. As illustrated, the system 10 (FIG. 1) includes a database 12 having any number of topic specific writing project folders 14,16,18. Each writing project may include a document setup preferences folder 20, an indexed note category folder 22, a table of contents folder 24, an uncategorized note folder 26, a footnote/endnote data folder 28, a bibliography data folder 30, and a wastebasket folder 32. Of particular interest is the indexed category folder 22 which contains all the sequenced or indexed categories/subcategories 34 as performed via the indexing module 300 (FIGS. 1, 4). It should be noted that each of the categories, subcategories, and notes stored therein are individually addressable. The remaining folders 24-32 exhibit a similar structure. An exemplary structure diagram illustrating the arrangement of topic specific notes, categories and subcategories is shown in FIG. 7.

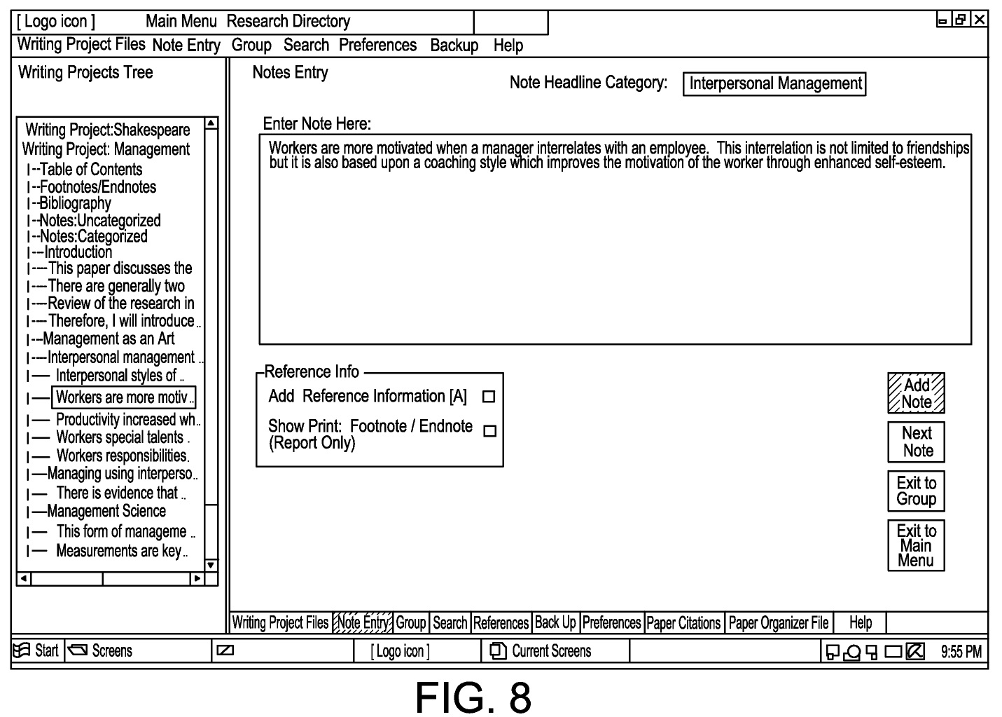

FIGS. 8-13 are exemplary screen shots of one embodiment of the present invention. In particular, FIG. 8 is an exemplary representation of a note entry display screen of the data collection module of the system. As illustrated, the note entry display screen may include an area or box for entering the data or notes. This permits the user to enter an indefinite number of notes. At any point the user may toggle to grouping and indexing by selecting the “Exit to Group” button. In addition, a reference information area is provided which allows the user to associate a note with an author source and create a bibliographic and/or citation reference. Also, category headlines and other sections of the document may be displayed in an outline or tree type format. The tree is updated as notes and/or groups are created.

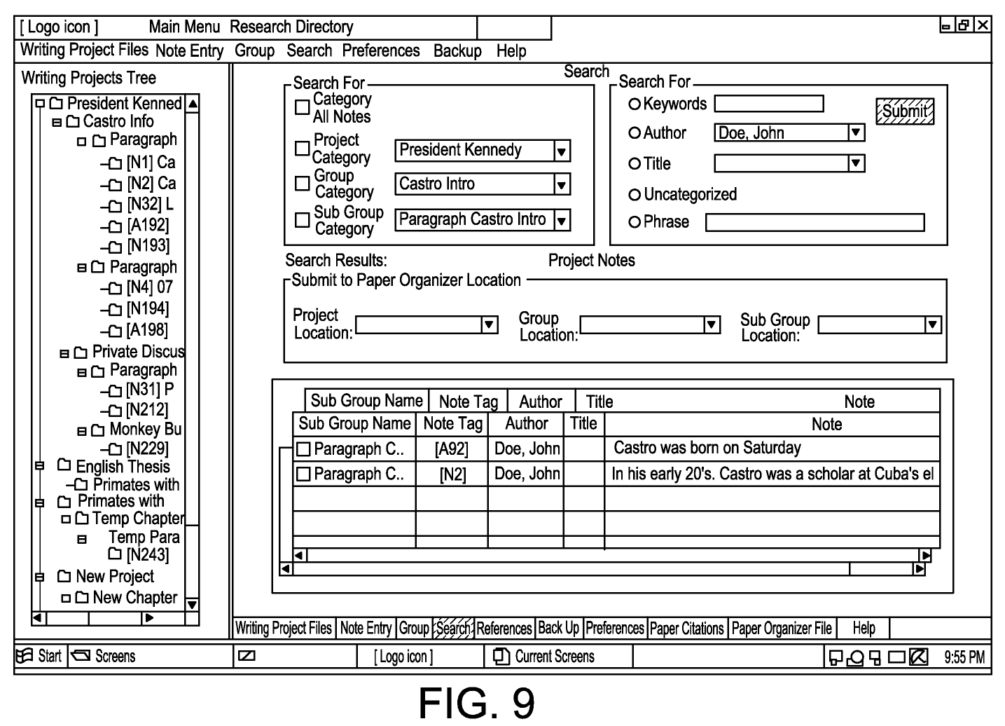

FIG. 9 is an exemplary representation of a note search display screen of the data collection module of the system for locating relevant notes from other previously created topic specific writing projects. As discussed previously, the search can be based on writing project, author, title, note content, and or group/sub-group category information. The search can span across related or unrelated writing projects and/or other shared writing databases. After the search results are returned, the user may immediately create the groups for the instant writing project, select the desired notes located by the search, and move those notes to the newly created group.

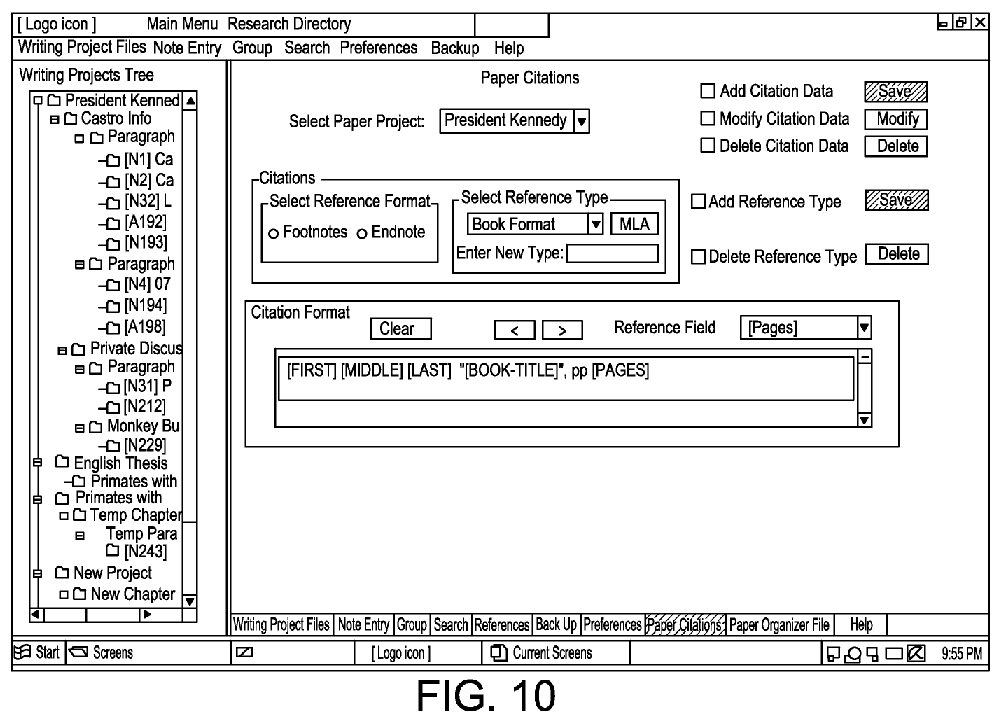

FIG. 10 is an exemplary representation of a citation builder display screen of the data collection module of the system for creating a particular citation format to be used in the topic specific writing project. The citation builder display screen allows the user to define footnote, endnote, and/or bibliographic formats for an infinite number of writing styles (e.g., MLA, APA, etc.). The footnote, endnote, and/or bibliographic format generally consists of a text string that may include hardcoded punctuation and pre-determined data fields.

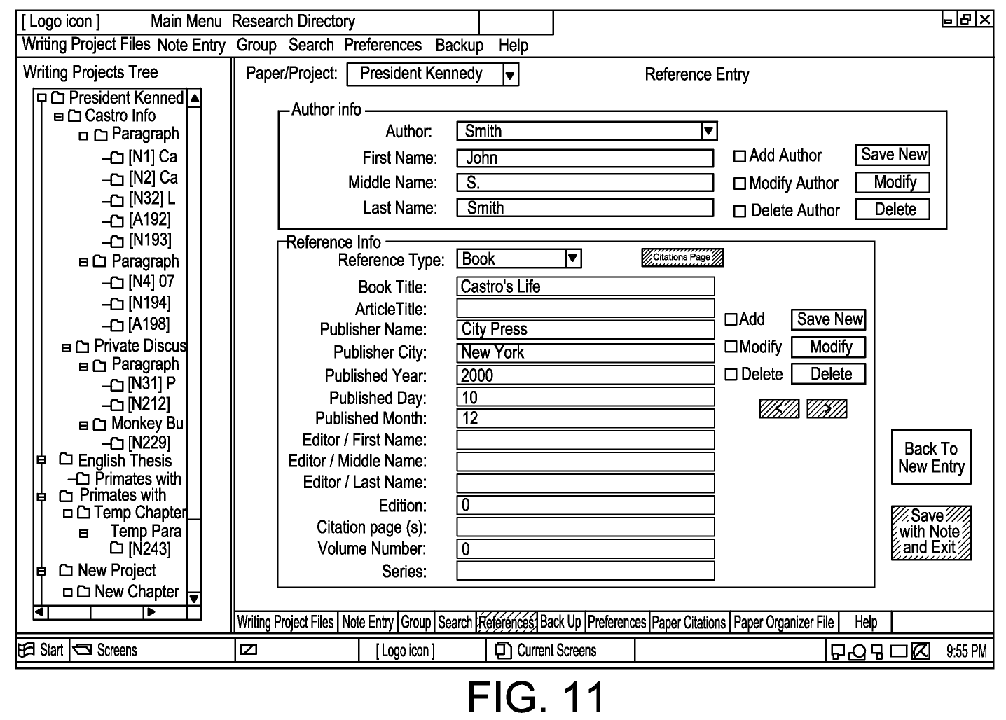

FIG. 11 is an exemplary representation of a reference information entry display screen of the data collection module of the system for obtaining source reference information (e.g., footnote, endnote, or bibliographic information) for each of the plurality of individual notes in the topic specific writing project. This reference information can then be used in conjunction with the citation formats previously created by the user. Additionally, repetitive data entry is minimized when multiple citations are required from the same author's work or authority.

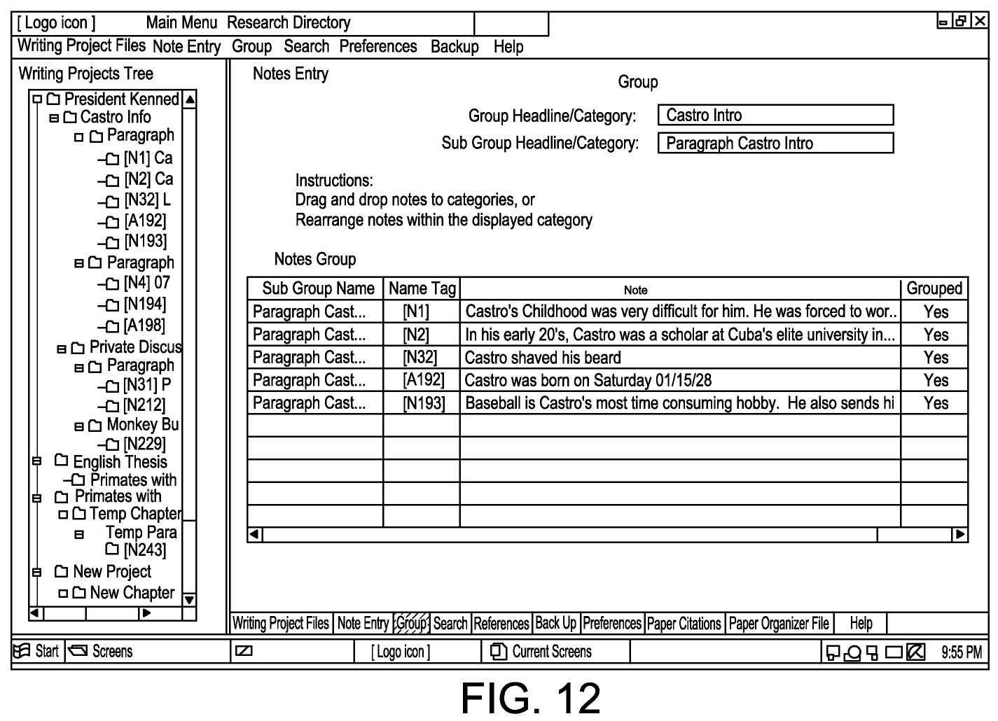

FIG. 12 is an exemplary representation of a group or category editing display screen of the indexing module of the system. The group editing screen allows the user to regroup note entries within existing groups and/or sub-categorize the note entries by creating a new group/sub-group. Here, the user may edit any of the active group/sub-group headline information as well as the content of the individual notes in the respective group, sub-group, or category.

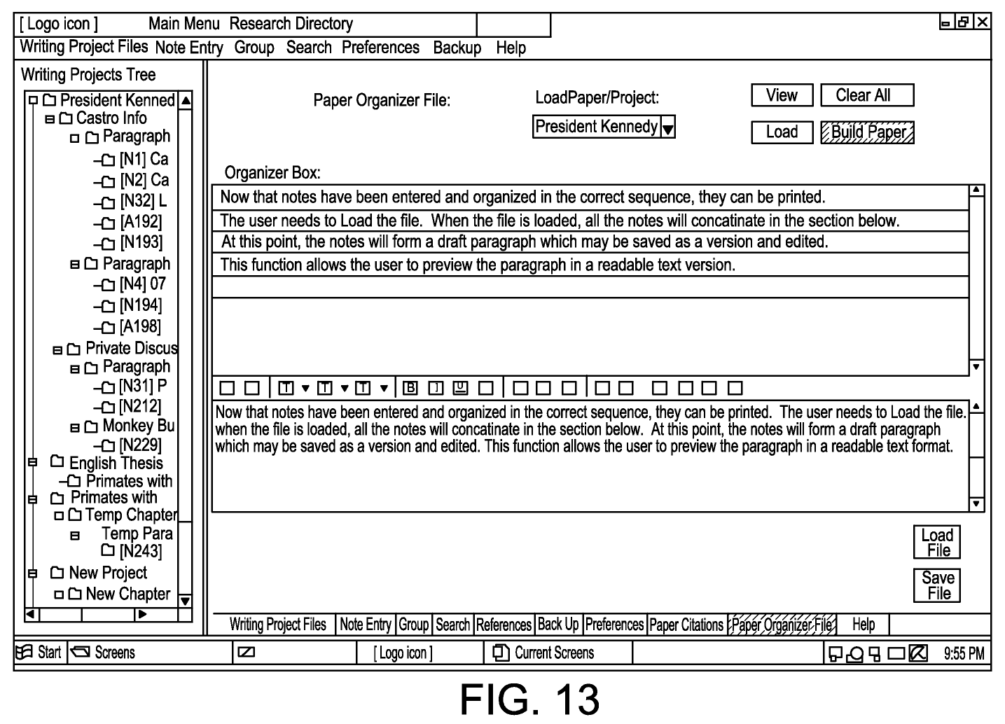

Lastly, FIG. 13 is an exemplary representation of an organizing and consolidating display screen of the previously described review/consolidating module of the system. As the user scrolls through the various groups, a concatenated draft view of the note entries is displayed in a draft view display area. Simultaneously, an organizer window of the consolidating display screen allows the user to re-sequence and/or edit the notes within the active group. The draft view display area is immediately updated upon re-sequencing or editing of the notes. Changes made to the note entries in the organizer window remain permanent whereas changes made to the text in the draft view are not. Once the user has finalized their changes, information within the draft view may be exported for further processing.

As should be apparent from the above discussion, there are several advantages to the present invention. For example, the present invention's GUI and visual hierarchy of individual notes and note groups/folders/subfolders makes it easier to retrieve, organize, and/or rearrange information. In addition, the present invention employs a writing database that can serve as a personalized or “career” database. The “career” database may be divided into various areas of expertise or projects which the user has worked on and collected information from various sources in the past. In other words, the database can store, according to each writing document project, the set of notes used to “build” that particular document. As the user's database expands, the user will find it convenient to reuse certain pieces of information from previously composed documents in new documents. The overall database hierarchy easily permits the user to locate and reuse certain select pieces of information. As such, the system provides a more efficient and organized approach to the reuse of select pieces of information, as opposed to manually searching through entire paragraphs or pages of documents previously composed.

Furthermore, the present invention also provides writers with an integrated tool to assist in the process of composing documents (for example, research papers, technical papers, manuals, novels, memos, essays, etc.). The present invention provides (1) the data retrieval and storage capabilities of a database, (2) the editing and output capabilities of a word processor, and (3) the organizational and rearrangement capability at the topic and sentence level through a (GUI) drag and drop hierarchy or environment. As mentioned previously, today's student or professional may have to employ several organizational systems and devices (e.g. word processors, database programs, index note cards, manila folders, paper pads, notebooks, pens, sticky notes, highlighters, etc.) to accomplish the task of composing a document. In addition the present invention allows for a convenient and systematic method of collecting, organizing, and storing any type of note for possible future use as, for example, those taken in a classroom, a research laboratory, or the like. As such, the present invention eliminates the need of for the prior art devices or techniques discussed previously as well as the confusion and frustration associated therewith.

The exemplary embodiments have been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of composing a document using a document composition system for a selected topic based on a plurality of information sources, the method comprising:
creating a topic specific writing project including a topic specific database via a database module;
receiving a data element into a first display of the system via an information gathering module;
storing the data element in an uncategorized portion of the database;
repeating the steps of receiving and storing to form a collection of data elements in the database;
indexing the collection of data elements in a second display of the system into a plurality of categories via an information categorizing module to form a series of articulatable data elements; and
consolidating the series of articulatable data elements of the collection in a third display of the system via an information consolidating module to form the document.

2. The method according to claim 1, wherein the step of creating the writing project further includes entering a plurality of document specific parameters.

3. The method according to claim 2, wherein the document specific parameters include at least one of an author information, a document title, a body style, a footnote format string, an endnote format string, or a bibliographical format string.

4. The method according to claim 1, wherein the step of receiving a data element further includes editing the data element.

5. The method according to claim 1, wherein the step of receiving a data element further includes searching a previously created topic writing database for a previously entered data element and importing the previously stored data element into the collection.

6. The method according to claim 1, wherein the step of storing further includes storing the data element in a master database.

7. The method according to claim 1, wherein the step of consolidating further includes editing the series of articulatable data elements.

8. The method according to claim 4, wherein the step of receiving the data element further includes entering source reference information and storing the source reference information in association with the respective data element in the database.

9. The method according to claim 8, wherein the step of consolidating further includes incorporating the source reference information for select ones of the data elements in the third display.

10. The method according to claim 1, further including the step of exporting the composed document to a word processor for further editing.

11. The method according to claim 1, further including the step of printing the composed document.

12. A document composition system for creating a document on a selected topic based on a plurality of associated information sources, the document composition system comprising:
a note gathering module including a first display window for acquiring a plurality of notes from the plurality of associated information sources;
a topic writing project database in communication with the note gathering module and capable of receiving and storing the plurality of notes;
a note indexing module in communication with the writing project database and including a second display window for prioritizing the plurality of notes, the plurality of notes being indexed into a series of logically related writing categories; and
a note consolidating module in communication with the writing project database, the note consolidating module including a third display window for consolidating select ones of the plurality of notes to create the document.

13. The document composition system of claim 12, wherein the note indexing module is further capable of editing the plurality of notes.

14. The document composition system of claim 12, wherein the note gathering module is further capable of editing the plurality of notes.

15. The document composition system of claim 12, wherein the series of logically related writing categories are further indexed into a series of logically related writing sub-categories.

16. The document composition system of claim 12, further comprising a source reference information module for creating a footnote, endnote, or bibliographical reference information for select ones of the plurality of notes and for storing the respective footnote, endnote, or bibliographical reference information in association with the select one of the plurality of notes in the writing database.

17. The document composition system of claim 16, wherein the note consolidating module is further capable of incorporating the respective reference information for the select ones of the plurality of notes in the third display window.

18. The document composition system of claim 16, wherein the source reference information module includes a fourth display window for creating, editing, and viewing the reference information.

19. The document composition system of claim 16, wherein the note gathering module is capable of accessing a previously created topic writing project database and selectively receiving at least one previously stored note.

20. The document composition system of claim 15, further including a table of contents creation module capable of accessing the note indexing module and generating a table of contents based on a header information of the indexed plurality of articulatable categories and sub-categories.

21. A computer program product comprising a computer-usable data carrier storing instructions that, when executed by a computer, causes the computer to perform a method comprising:
creating a topic specific writing project including a topic specific database via a database module;
receiving a data element into a first display of the system via an information gathering module;
storing the data element in an uncategorized portion of the database;
repeating the steps of receiving and storing to form a collection of data elements in the database;
indexing the collection of data elements in a second display of the system into a plurality of categories via an information categorizing module to form a series of articulatable data elements; and
consolidating the series of articulatable data elements of the collection in a third display of the system via an information consolidating module to form the document.
